(19) United States
(12) Patent Application Publication
(10) Pub. No.: US 2023/0339215 A1
(43) Pub. Date: Oct. 26, 2023

(54) LAMINATED PANE WITH FUNCTIONAL ELEMENT WHICH CAN BE SWITCHED IN SEGMENTS AND HAS ELECTRICALLY CONTROLLABLE OPTICAL PROPERTIES

(71) Applicant: SAINT-GOBAIN GLASS FRANCE, COURBEVOIE (FR)

(72) Inventors: Alexandre FESSEMAZ, AACHEN (DE); Li-Ya YEH, GEILENKIRCHEN (DE)

(21) Appl. No.: 18/005,002

(22) PCT Filed: Jul. 26, 2021
(86) PCT No.: PCT/EP2021/070783

§ 371 Date: Jan. 10, 2023

(30) Foreign Application Priority Data
Aug. 3, 2020 (EP) 20189165.2

(51) Int. Cl. B32B 17/10; B32B 3/26

(52) U.S. Cl. CPC B32B 17/10504; B32B 17/10036; B32B 3/266; B32B 17/10807; B32B 17/10192; B32B 17/10761; B32B 2307/202; B32B 2307/206; B32B 2307/7376; B32B 2419/00; B32B 2605/006

(57) ABSTRACT

A laminated pane with an electrically controllable functional element switchable in segments, includes first and second panes joined to one another via an intermediate layer, and a functional element embedded in the intermediate layer. The functional element includes, flat atop one another in this order, a first carrier film, a first flat electrode, an active layer, a second flat electrode, and a second carrier film, the first flat electrode is divided into segments by at least one separating line, a group of first bus bars electrically conductively contacts the first flat electrode, at least one second bus bar electrically conductively contacts the second flat electrode. In the region of a separating line a recess is introduced in the first electrode, which recess surrounds a portion of the first electrode and electrically insulates the portion situated within the recess from the surface region of the first electrode situated outside the recess.

The invention relates to a laminated pane with a functional element that can be switched in segments and has electrically controllable optical properties, a method for its production, and its use.

For protection against dazzling of the driver or other occupants, conventional motor vehicles have mechanical sun visors. These are hinge-mounted on the vehicle roof and can be pivoted downward as needed to prevent or at least to mitigate the dazzling of the driver or front-seat passenger, for example, when the sun is low.

Also known are windshields into which a sun visor is integrated in the form of a functional element with electrically adjustable optical properties, in particular with electrically adjustable transmittance or scattering properties. Thus, the driver can control the transmittance behavior of the windshield itself relative to sunlight; the conventional mechanical sun visor can be dispensed with. By this means, the weight of the vehicle can be reduced and space is gained in the roof region. In addition, electrical control of the sun visor is more convenient for the driver than the manual folding down of the mechanical sun visor.

Electrically adjustable sun visors are, moreover, used in glass roofs of motor vehicles. In particular, in the case of large-area panoramic glass panes, there is a need to variably control the transmittance of the pane. Depending on the position of the sun, it is necessary to dim only subregions of the pane, or also to make the entire area non-transparent as a privacy screen in the parked vehicle.

One possible electrically switchable controllable functional element for realizing the adjustable sun visor is a so-called “PDLC” functional element (polymer dispersed liquid crystal). The active layer contains liquid crystals that are incorporated into a polymer matrix. When no voltage is applied, the liquid crystals are randomly oriented, resulting in strong scattering of the light passing through the active layer. When a voltage is applied to the flat electrodes, the liquid crystals align themselves in a common direction and the transmittance of light through the active layer is increased. The PDLC functional element acts less by reducing total transmittance, but rather by increasing scattering to ensure protection against dazzling.

Windshields with electrically adjustable sun visors are known, for example, from DE 102013001334 A1, DE 102005049081 B3, DE 102005007427 A1, and DE 102007027296 A1. DE 102010021563A1 describes a windshield with an electrically adjustable sun visor that is switchable in subregions wherein the darkening of the individual elements is controllable via a capacitive sensor arrangement in the edge region of the sun visor.

The electrical contacting of electrically controllable functional elements is usually done via bus bars that are attached on the flat electrodes in the edge region of the functional element and make electrically conductive contact therewith. By connecting the bus bars to an external voltage source, for example, via flat conductors attached to the bus bars, a voltage is applied to the flat electrodes and the active layer of the functional element is switched. The active layer of the functional element is generally arranged between two polymeric carrier films that carry the flat electrodes on the surface facing the active layer. Such electrically switchable functional elements as multilayer films are commercially available. For selective contacting of a flat electrode, it must first be exposed out of the multilayer film. In a first step, one carrier film of the multilayer film including the flat electrode situated on the carrier film is cut back. The active layer thus exposed is removed, for example, by mechanical abrasion using a solvent. After removal of the active layer, the flat electrode adjacent thereto is revealed and can be electrically conductively contacted. Special care must be taken when cutting back the carrier layer in the first step. The flat electrode to be contacted must not be damaged under any circumstances. Thus, manufacturers of multilayer films very carefully cut the upper carrier film back, often selecting a slightly oblique cut. This creates an inhomogeneous cut edge. In such a prepared multilayer film, the separating lines that electrically isolate the individual segments from one another are generally introduced by laser methods. It is observed that, in the region of inhomogeneous cut edge of the multilayer film, a discontinuous separating line can occur. This results in incomplete separation of adjacent segments and leakage current between them.

From WO 2020 083562 A1 and DE 20 2019 100 577 U1, laminated panes with functional elements with electrically controllable optical properties that can be switched in segments are known. Leakage currents between adjacent segments are to be expected along the cut edges of functional elements implemented as multilayer films.

The object of the present invention is to provide a laminated pane having a functional element that is switchable in segments with electrically controllable optical properties and that has improved electrical contacting with reduced leakage current between adjacent segments.

The object of the present invention is accomplished by a laminated pane having a functional element that is switchable in segments with electrically controllable optical properties according to the independent claim 1. Preferred embodiments are apparent from the dependent claims.

The laminated pane according to the invention contains a functional element that is switchable in segments with electrically controllable optical properties, whose optical properties can be adjusted as a function of the voltage applied. The functional element is embedded in the intermediate layer of the laminated pane. The intermediate layer joins the first pane and the second pane of the laminated pane. The adjustable functional element includes an active layer between a first flat electrode and a second flat electrode. The active layer has the adjustable optical properties that can be controlled by the voltage applied to the flat electrodes. The flat electrodes and the active layer are typically arranged essentially parallel to the surfaces of the first pane and the second pane. The flat electrodes are electrically conductively connected to bus bars, via which the functional element can be connected to an external voltage source. In order to be able to switch the functional element in sections, in the form of individual segments, these must be electrically controllable individually. For this, the first flat electrode is divided into multiple segments by at least one separating line. The separating line can also be referred to as an isolating line and is responsible for electrical separation of the individual segments of the first flat electrode from one another. A group of first bus bars is used to make electrically conductive contact with the first flat electrode, wherein each segment of the first flat electrode is contacted by one bus bar of the group of the first bus bars. The second flat electrode is electrically conductively contacted by at least one second bus bar. According to the invention, in the region of at least one separating line, at least one recess is introduced in the first flat electrode. The recess encloses a portion of the first flat electrode, wherein the portion situated within the recess is electrically insulated from the surface region of the first flat electrode situated outside the recess.

By means of the recess according to the invention, defective regions of the separating line where leakage currents occur or are to be expected can be electrically insulated. The separating line and the recess overlap, with the defective region of the separating line located within the recess. Thus, leakage currents between adjacent segments of the functional element are avoided.

The separating lines are defined as continuous line-shaped regions that can be linear as well as curved or wavy and, accordingly, do not enclose any surface areas of the functional element. The recesses are implemented as closed contours, wherein the circumferential contour line of the recess encloses a surface region of the functional element. Within the recess, at least the subregion of the first flat electrode surrounded by the recess is electrically insulated from the surface region of the first flat electrode situated outside the recess. No bus bars that contact this enclosed subregion of the first flat electrode are installed within the recess. Therefore, the functional element is not switchable within a recess.

In the context of the invention, a recess includes an enclosed area, with the electrical separation between the enclosed portion of the recess and the area surrounding the recess provided by a circumferential separating line. Depending on whether this separating line is introduced only selectively in the flat electrode or whether the separating line cuts through multiple layers of the functional element, portions of the area enclosed by the recess can also be removed. If the separating line of the recess penetrates all layers of the functional element, a through-opening is created. A through-opening is advantageous in terms of simpler production of the recess using mechanical methods. Furthermore, when there is a through-opening, this ensures that there is complete electrical separation between the subregion of the area situated within the recess and the region of the flat electrode surrounding the recess. In the region of the through-opening, in addition to the region of the first flat electrode situated within the recess, the regions of the carrier films, the active layer, and the second flat electrode that are in projection relative to the region of the first flat electrode to be insulated are also removed.

In another preferred embodiment, only a noncontinuous partial recess is introduced into the functional element. A partial recess can, for example, consist of a bore that cuts through the first flat electrode as well as the layers adjacent the first flat electrode on the surface facing away from the active layer. The bore can optionally also project beyond the first flat electrode into the active layer and/or other layers. The region situated within the recess and separated from the surrounding layers by the circumferential contour of the recess can remain within the recess or be removed therefrom.

In another possible embodiment, the at least one recess is introduced only into the first flat electrode. This is possible, for example, by means of laser processes, in that a laser beam is focused onto the first flat electrode through the first carrier film.

In the context of the invention, “a separating line” means a linear region within the flat electrode that is not electrically conductive and which extends over the entire thickness of the flat electrode. The separating line, which can also be referred to as an insulation line, optionally has at least one defect at the position of which the local sheet resistance is lower than the sheet resistance of the separating line outside the defect. The purpose of the separating lines is to subdivide the first flat electrode into segments that are to be electrically insulated from one another. In the region of the separating lines, the electrically conductive coating of the flat electrode is removed or decomposed. If the separating lines have defects, the electrically conductive coating is only insufficiently decomposed in these regions such that electrically conductive particles remain in the region of the separating line. In the region of the defect, the sheet resistance is thus substantially lower than in the region of the separating line, as a result of which, in the region of the defect, electric current is conducted and the two adjacent segments of the flat electrode are electrically contacted with one another.

The separating line is not electrically conductive such that, in the region of the separating line, the electrical resistance is, for example, on the order of magnitude of the resistances of the carrier films and of the active layer. Traces of the flat electrode possibly remaining in the region of the separating line are negligible. The resistance in the region of the separating line is particularly preferably greater than 10⁶Ω.

In regions where the defects of the separating line and resulting leakage currents between segments can occur, the resistance is substantially lower than in the region of the separating line. The resistance in the region of such defects is particularly preferably less than 10⁶Ω. The invention provides a remedy here by means of the recesses introduced according to the invention. The surface region of the first flat electrode enclosed by a recess has electrical resistance of preferably at least 10⁶Ω.

The structure of the laminated pane according to the invention enables the active layer to be selectively switched in sections, with the selectively switchable regions of the active layer corresponding to a projection of the segments of the first flat electrode onto the active layer. For the selective activation of the segments, the opposing poles of a voltage source are connected, depending on the desired circuit diagram of the active layer, to the bus bars of the first flat electrode and the second flat electrode. A first pole of the voltage source is connected to the second bus bar(s) of the second flat electrode, whereas the opposite pole of the voltage source is connected to the first bus bars, which are contacted in the region of the segments of the first flat electrode to be activated. Consequently, there is an electrical potential difference between the flat electrodes only in the regions of the functional element in which the corresponding segments of the first flat electrode are connected to the voltage source. Accordingly, the active layer of the functional element is also switched only in these regions. The separating lines between the individual segments of the first flat electrode ensure that no current flow occurs via other segments of the coating. The recesses of the first flat electrode according to the invention also prevent current leakages between the segments. The selective activation of the segments of the first flat electrode to which a voltage is applied is done, for example, via an external control unit.

The functional element has multiple side edges, particularly preferably four side edges. The functional element can, however, also include more than four side edges. In each case, at least two side edges of the functional element are positioned opposite one another, essentially in pairs. In the case of an embodiment with four side edges, this yields two pairs of two opposite side edges each. The opposite side edges of a functional element can run parallel to one another or nonparallel. The side edges need not be straight, but often have a curve. The length of opposite side edges can differ from one another. For example, the functional element can have a trapezoidal outline.

In a preferred embodiment, the functional element has multiple side edges, for example, four side edges. The bus bars of the first group, which electrically contact the first flat electrode, are situated near one another on at least one side edge, in each case within the segments delimited by the separating lines. Optionally, the first flat electrode can be contacted by the two first bus bars per segment in each case. The two first bus bars contacting the same segment are located opposite each other at two opposite edges of the functional element.

The width of a segment of the first flat electrode is defined as the distance between two adjacent separating lines or, in the case of an edge segment, as the distance between the side edge and the nearest separating line. The separating lines and the first bus bars are preferably arranged at an angle of 70° to 110° relative to one another, particularly preferably at an angle of 90°±5° relative to one another. The separating lines can be linear, nonlinear or, also, wave-shaped. As for the spatial arrangement of separating lines and first bus bars, in the case of nonlinear or wave-shaped separating lines, the preferred direction of the separating line is taken into account.

The segments of the first flat electrode are arranged essentially parallel to one another, with the segments extending continuously from one side edge of the functional element to an opposite side edge.

The number of segments within the first flat electrode can vary depending on the field of application of the glazing and is usually between 2 and 20, preferably between 3 and 10.

The inventors have found that defective separating lines occur more frequently in particular in the edge region of the functional element in which the bus bars are applied to the flat electrodes. These can result in leakage currents between adjacent segments. To apply the second bus bars on the second flat electrode, the first carrier film with the first flat electrode is first removed by cutting back, and then the second flat electrode is exposed by removing the active layer. In the region of the cut edge of the back-cut, changes in the first flat electrode occur, making it difficult to achieve complete electrical separation by means of the separating lines to be introduced. In light of this, it is advantageous not to first subject the functional element to quality control for identification of defects, but, instead, to provide a recess in the vicinity of the second bus bar in advance. Analogously with the process described, to establish contact of the first bus bar with the first flat electrode, the second carrier film is cut back along with the second flat electrode and the active layer is removed. The first flat electrode with the separating lines introduced therein is generally hardly impaired in this process. However, at the beginning of production, the functional element is cut to the desired dimension in which it is to be incorporated in the glazing. This forms a circumferential edge of the functional element. The separating lines run, starting from the edge on which the bus bars of the first group are attached, preferably between adjacent bus bars of the first group all the way to the circumferential edge of the functional element. In the vicinity of this cut edge as well, defects in the separating lines can also occur more frequently; these can be avoided by means of the recesses according to the invention.

Preferably, the functional element has, at the edge adjacent the first bus bar(s) and/or adjacent the second bus bar, at least one recess in the region of at least one separating line. In a particularly preferred embodiment, all separating lines have recesses, in each case in the vicinity of the second bus bar, preferably in each case in the vicinity of the second bus bar and between adjacent bus bars of the first group.

Preferably, at least one recess is provided in the region of a separating line in the vicinity of the second bus bar. Preferably, a plurality of recesses are provided in the region of the separating lines in the vicinity of the second bus bar. Preferably, each separating line carries at least one recess. Preferably, the distance between at least one recess and the second bus bar is 0.2 mm to 20.0 mm, preferably 0.2 mm to 10.0 mm, particularly preferably 0.5 mm to 5.0 mm, with the recess offset by this amount in the direction of the surface center of the functional element. Recesses at this distance from the second bus bar are preferably provided on multiple separating lines, particularly preferably on all separating lines. The distance between the recess and the bus bar is determined as the distance between the mutually closest sections of the bus bar and the respective recess. Said distances of the recess from the second bus bar are selected such that, in this region, the cut edge of the first carrier film is usually positioned with the first flat electrode. In this region of the cut edge, the separating lines particularly frequently have defects such that these defects are electrically isolated by means of the recesses and are thus eliminated.

Preferably, recesses are also provided in the region of the separating lines at the edge of the functional element that carries the bus bars of the group of first bus bars. The first bus bars contact, in each case, a segment of the first flat electrode. The segments introduced into the first flat electrode are electrically isolated from one another by separating lines, with the separating lines running between adjacent first bus bars and intended, in this region as well, to prevent current flow between adjacent segments. At least one recess is preferably introduced into the region of at least one separating line which is located between two adjacent bus bars of the group of the first bus bars. The region between two bus bars is described as the region that is located within a section between the edge of the first bus bars facing the surface center of the glazing and the nearest section of the circumferential edge. The recess is located in the region of the separating line, i.e., overlaps the separating line. Preferably, the at least one recess is located in the region of the separating line between adjacent bus bars of the first group at a distance of 0.0 mm to 5.0 mm, particularly preferably 0.0 mm to 2.0 mm, from the nearest section of the circumferential edge of the functional element. This section of the circumferential edge is formed by the first carrier film with the first flat electrode such that the first flat electrode is severed by a cut along the circumferential edge. Increased defects of the separating lines occur in the region of this cut edge, which defects are electrically isolated from the surrounding surface by a recess in the defect-prone region of the separating lines. Thus, said distance of the recess from the nearest edge has proved useful for effectively eliminating defects of the separating line.

The outer edge of the functional element that determines the areal dimension of the functional element is referred to as the “circumferential edge of the functional element”. The circumferential edge can be formed in sections by a common edge of the first carrier film and the second carrier film. In edge sections along which a bus bar is contacted, the edge of one carrier film is, in each case, set back in the direction of the surface center of the functional element. At an edge along which the first bus bars are contacted, the edge of the second carrier film with the second flat electrode is set back in the direction of the surface center of the functional element. At the edge on which the second bus bar is contacted on the second flat electrode, the first carrier film is likewise set back in the direction of the surface center of the functional element.

The functional element can optionally be provided at one edge in each case or at multiple, preferably two, edges in each case with a second bus bar. The group of the first bus bars can also be attached at only one side or distributed over two opposite side edges. Depending on the size and dimensions of the functional element, multiple side edges, each with the second bus bar and/or with bus bars of the first group, can be advantageous in terms of uniform activation and switching of the functional element.

In a preferred embodiment of the laminated pane, the diameter of the at least one recess is 0.5 mm to 5.0 mm, preferably 0.8 mm to 3.0 mm, particularly preferably 1.0 mm to 2.5 mm. The diameter of the recess is defined as the maximum edge dimension of the recess. In these ranges, the recess is, on the one hand, small enough that it is not visually noticeable and is preferably concealed by the masking print often used in the edge region of automotive glazings. On the other hand, this dimension is sufficient to enclose the common defects of the separating lines.

The shape of the recess can, in principle, be freely selected. Shapes with rounded corners are preferable in terms of easy separability and a simple separation method.

The recesses can be introduced by mechanical methods such as cutting or punching or by contactless methods such as laser methods. Mechanical methods are easy to implement but have the disadvantage of having only low precision and, in practice, only recesses in the form of through-holes can be made mechanically. Laser methods offer high precision in terms of cutting geometries, also enable recesses with small radii and selective processing of individual layers of the layer stack. For example, a laser beam can even be focused through the carrier films selectively on the first flat electrode and can cut it or decompose it, as a result of which the recess according to the invention is formed. The term “laser methods” includes, for example, laser methods for ablation of the first flat electrode within the recess, methods for selective decomposition of the first flat electrode along the circumferential contour of the recess or methods for laser drilling.

In a particularly preferred embodiment, the recesses are introduced into the functional element by means of laser drilling. Preferably, in this case, starting from the outer surface of the carrier film that is oriented in the direction of one pane of the laminated pane, a laser bore that protrudes into the first flat electrode and completely cuts through the first flat electrode along the circumferential cut edge of the recess is introduced into the functional element. Optionally, this laser bore can also protrude into the active layer or the second carrier film or cut completely through the second carrier film, creating a through-opening. Pulsed lasers are primarily used for laser drilling of workpieces, with the workpiece and the laser moved relative to one another such that multiple successive pulses impinge at the same point on the workpiece and the material of the workpiece is melted and vaporized. Recesses produced by laser drilling have high geometric precision and reliable electrical separation of the surface portion of the flat electrode within the recess from the surface portion outside the recess.

The electrical contacting of the bus bars to an external power source is realized by suitable connecting cables, for example, foil conductors. Suitable external control elements for activating the individual segments are known to the person skilled in the art.

The electrical adjustment of the functional element is done, for example, by knobs, rotary controls, or sliders, that are, for example, integrated into the dashboard of a vehicle. However, a switch area, for example, a capacitive switch area, for control can also be integrated into the laminated pane. Alternatively, the functional element can also be controlled by contactless methods, for example, by gesture recognition, or as a function of the pupil or eyelid state detected by a camera and suitable evaluation electronics.

The separating lines are introduced into the flat electrodes such that the segments of the first flat electrode are electrically isolated from one another. The individual segments are connected to the voltage source independently of one another such that they can be actuated separately. Thus, different regions of the functional element can be switched independently. Particularly preferably, the segments are arranged horizontally in the installed position. Thus, the height of the non-transparent region of the functional element can be controlled by the user. The term “horizontal” is construed broadly here and refers to a propagation direction that runs between the side edges of the laminated pane, for example, the side edges of a windshield or roof panel. The separating lines need not necessarily be straight, but, instead, can even be slightly curved, preferably adapted to any curvature of the nearest pane edge, in particular essentially parallel to the front roof edge of a windshield. Of course, vertical separating lines are also conceivable.

The separating lines preferably have a width of 5 μm to 500 μm, particularly preferably 40 μm to 200 μm, in particular 40 μm to 150 μm. The width of the segments, i.e., the distance between adjacent separating lines, can be suitably selected by the person skilled in the art in accordance with the requirements in the individual case.

The separating lines can be introduced by laser ablation, mechanical cutting, or etching during production of the functional element. Already laminated multilayer films can also be subsequently segmented by laser ablation.

The recesses can, in principle, be introduced by means the same methods as the separating lines. The recess can thus be produced by introducing a closed contour line in the widths preferred for the separating lines.

The bus bars are, for example, connected to the flat electrodes as strips of an electrically conductive material or electrically conductive imprints. Preferably, the bus bars are implemented as electrically conductive imprints including silver.

In an advantageous embodiment, the functional element is a PDLC functional element (polymer dispersed liquid crystal). The active layer of a PDLC functional element contains liquid crystals that are embedded in a polymer matrix. When no voltage is applied to the flat electrodes, the liquid crystals are aligned in a disorderly manner, resulting in strong scattering of the light passing through the active layer. When a voltage is applied to the flat electrodes, the liquid crystals align themselves in a common direction and the transmittance of light through the active layer is increased. Such a functional element is known, for example, from DE 102008026339 A1.

In other possible embodiments, the active layer is an SPD, an electrochromic, or an electroluminescent layer.

An SPD (suspended particle device) functional element contains an active layer including suspended particles, with the absorption of light by the active layer being variable by application of a voltage to the flat electrodes. The change in absorption is based on the alignment of the rod-shaped particles in the electric field when electric voltage is applied. SPD functional elements are known, for example, from EP 0876608 B1 and WO 2011033313 A1.

In an electrochromic functional element, the active layer of the functional element is an electrochemically active layer. The transmittance of visible light depends on the rate of ion storage in the active layer, with the ions provided, for example, by an ion storage layer between an active layer and a flat electrode. The transmittance can be influenced by the voltage applied to the flat electrodes, which causes a migration of the ions. Suitable functional layers contain, for example, at least tungsten oxide or vanadium oxide. Electrochromic functional elements are known, for example, from WO 2012007334 A1, US 20120026573 A1, WO 2010147494 A1, and EP 1862849 A1.

In electroluminescent functional elements, the active layer contains electroluminescent materials, in particular organic electroluminescent materials whose luminescence is stimulated by the application of a voltage. Electroluminescent functional elements are known, for example, from US 2004227462 A1 and WO 2010112789 A2. The electroluminescent functional element can be used as a simple light source or as a display with which any displays can be shown.

In a particularly preferred embodiment, the laminated pane is a windshield of a motor vehicle. The windshield has an upper edge and a lower edge as well as two side edges extending between the upper edge and the lower edge. The term “upper edge” refers to that edge which is intended, in the installed position, to point upward in the direction of the vehicle roof. The upper edge is usually referred to as the “roof edge” or “front roof edge”. The term “lower edge” refers to that edge which is intended, in the installed position, to point downward toward the hood of the vehicle. The lower edge is generally referred to as the “engine edge”.

Windshields have a central field of vision whose optical quality is subject to stringent requirements. The central field of vision must have high light transmittance (typically greater than 70%). Said central field of vision is, in particular, that field of vision that is referred to by the person skilled in the art as the field of vision B, vision region B, or zone B. The field of vision B and its technical requirements are specified in Regulation No. 43 of the Economic Commission for Europe of the United Nations (UN/ECE) (ECE-R43, “Uniform Provisions Concerning the Approval of Safety Glazing Materials and Their Installation on Vehicles”). The field of vision B is defined there in Annex 18.

In this embodiment of the windshield, the functional element is a sun visor and is arranged above the central field of vision (field of vision B). This means that the functional element is arranged in the region between the central field of vision and the front roof edge of the windshield. The functional element need not cover the entire region but is positioned completely within this region and does not protrude into the central field of vision. In other words, the functional element is nearer the upper edge of the windshield than the central field of vision. Thus, the transmittance of the central field of vision is not impaired by the functional element, which is situated at a position similar to that of a conventional mechanical sun visor in the downward pivoted state.

The intermediate layer in the central field of vision of the windshield is clear and transparent. This ensures that the through-vision through the central field of vision is unrestricted such that the pane can be used as a windshield. The term “a transparent thermoplastic layer” means a layer with light transmittance in the visible spectral range of at least 70%, preferably at least 80%. The transparent intermediate layer is present at least in the field of vision A, preferably also in the field of vision B per ECE-R43.

The windshield is preferably intended for a motor vehicle, particularly preferably for a passenger car.

The functional element as a sun visor has multiple lamellae, which correspond in their dimensions and arrangement to the segments of the first flat electrode and can be switched selectively. At least two separating lines, that run essentially parallel to the front roof edge and divide the flat electrode into at least three segments, is introduced into the first flat electrode. The segments thus extend between the two side edges of the windshield. Each segment of the first flat electrode is in each case contacted by at least one first bus bar that are attached on the first flat electrode in the vicinity of the side edge, or, in the case of multiple bus bars per segment, in the vicinity of the side edges. The second flat electrode of the functional element is contacted via at least one second bus bar, which is arranged adjacent the front roof edge at a side edge. A recess is provided at the side edges in each case in the region in which the cut edge of the first carrier film with a first flat electrode is located, which recess overlaps with the separating lines. The bus bars arranged at the side edges and, optionally, at the roof edge are concealed in the edge region of the pane by the opaque masking print customarily used for windshields.

In one possible embodiment, a region of the thermoplastic intermediate layer, via which the functional element is joined to the outer pane or the inner pane, is tinted or colored. The transmittance of this region in the visible spectral range is thus reduced compared to a non-tinted or non-colored layer. The tinted/colored region of the thermoplastic intermediate layer thus lowers the transmittance of the windshield in the region of the sun visor. In particular, the aesthetic impression of the functional element is improved because the tinting results in a more neutral appearance that is more pleasant to the observer.

The tinted or colored region of the thermoplastic intermediate layer preferably has transmittance in the visible spectral range of 10% to 50%, particularly preferably of 20% to 40%. Particularly good results in terms of protection against dazzling and optical appearance are thus achieved.

A windshield with an electrically adjustable sun visor comprises at least an outer pane and an inner pane that are joined to one another via an intermediate layer. The windshield is intended, in a window opening of a vehicle, to separate the interior from the external surroundings. In the context of the invention, “inner pane” means the pane of the windshield facing the interior (vehicle interior). “Outer pane” means the pane facing the external surroundings. The first pane and the second pane of the laminated pane according to the invention are the inner pane and the outer pane of such a windshield.

In another preferred embodiment of the laminated pane according to the invention, it is used as a roof panel of a motor vehicle. The roof panel comprises a front roof edge that is adjacent the windshield of the vehicle, a rear roof edge that points in the direction of the rear window, and two side edges that extend along the vehicle doors between the front roof edge and the rear roof edge. The functional element is preferably designed as large-area shading of the roof panel, wherein the functional element is arranged on an area of at least 80% of the entire through-vision region of the roof panel, preferably at least 90%, for example, 100%, of the entire through-vision region.

The functional element as roof shading likewise has multiple lamellae, which correspond in their dimensions and arrangement to the segments of the first flat electrode and can be switched selectively. The segments of such a vehicle roof are substantially larger in area than in sun visors. At least one separating line that runs essentially parallel to the front roof edge of the laminated pane and divides the flat electrode into at least two segments is introduced into the first flat electrode. The functional element is preferably divided into 2 to 6, particularly preferably into 3 to 4 lamellae, wherein the lamellae run essentially orthogonal to the direction of travel of the vehicle. The segments thus extend between the two side edges of the roof panel and the separating lines run from one side edge in the direction of the other side edge. The contacting with bus bars and the division of the segments is essentially as described for the implementation of the windshield. In addition, the functional element can optionally carry another bus bar that is attached at the rear roof edge. The bus bars arranged at the side edges and at the roof edges are concealed by the opaque masking print customarily used in the edge region of the pane.

In a preferred embodiment of the roof panel, the region of the thermoplastic intermediate layer, via which the functional element is joined to the outer pane or to the inner pane, is tinted or colored. The transmittance of this region in the visible spectral range is thus reduced compared to a non-tinted or non-colored layer. The tinted/colored region of the thermoplastic intermediate layer thus lowers the transmittance of the roof panel. The tinted or colored region of the thermoplastic intermediate layer preferably has transmittance in the visible spectral range of 10% to 50%, particularly preferably of 20% to 40%. This achieves particularly good results in terms of glare protection and optical appearance.

The first pane and the second pane of the laminated pane according to the invention constitute the inner pane and the outer pane of the roof panel.

The first bus bars and the second bus bars comprise an electrically conductive structure, preferably containing silver, and have a thickness of 5 μm to 40 μm.

The bus bars are intended to be connected to an external voltage source such that there is a difference in electrical potential between the first flat electrode and the second flat electrode.

The attachment of the bus bars can be done in particular by placement, printing, soldering, or gluing.

In a preferred embodiment, the bus bars are implemented as a printed and baked conductive structure. The printed bus bars contain at least one metal, preferably silver. The electrical conductivity is preferably realized via metal particles contained in the bus bar, particularly preferably via silver particles. The metal particles can be situated in an organic and/or inorganic matrix such as pastes or inks, preferably as baked screen printing paste with glass frits. The layer thickness of the printed bus bars is preferably from 5 μm to 40 μm, particularly preferably from 8 μm to 20 μm, and most particularly preferably from 10 μm to 15 μm. Printed bus bars with these thicknesses are technically simple to realize and have advantageous current carrying capacity.

Alternatively, the bus bars are implemented as strips of an electrically conductive film. In that case, the bus bars contain, for example, at least aluminum, copper, tinned copper, gold, silver, zinc, tungsten, and/or tin or alloys thereof. The strip preferably has a thickness of 10 μm to 500 μm, particularly preferably of 30 μm to 300 μm. Bus bars made of electrically conductive films with these thicknesses are technically simple to realize and have advantageous current carrying capacity. The strip can be electrically conductively connected to the flat electrode, for example, via a soldering compound, an electrically conductive adhesive, or an electrically conductive adhesive tape, or by direct placement. To improve the conductive connection, a silver-containing paste, for example, can be arranged between the flat electrode and the bus bar.

The first flat electrode and the second flat electrode are formed in each case by an electrically conductive layer. These electrically conductive layers contain at least a metal, a metal alloy, or a transparent conductive oxide, preferably a transparent conductive oxide, and have a thickness of 10 nm to 2 μm. The flat electrodes are preferably transparent. Here, “transparent” means permeable to electromagnetic radiation, preferably electromagnetic radiation of a wavelength from 300 nm to 1.300 nm and, in particular, to visible light. Electrically conductive layers according to the invention are known, for example, from DE 20 2008 017 611 U1, EP 0 847 965 B1, or WO2012/052315 A1. They typically contain one or more, for example, two, three, or four, electrically conductive, functional individual layers. The functional individual layers preferably contain at least one metal, for example, silver, gold, copper, nickel, and/or chromium, or a metal alloy. The functional individual layers particularly preferably contain at least 90 wt.-% of the metal, in particular at least 99.9 wt.-% of the metal. The functional individual layers can be made of the metal or the metal alloy. The functional individual layers particularly preferably contain silver or a silver-containing alloy. Such functional individual layers have particularly advantageous electrical conductivity with, at the same time, high transmittance in the visible spectral range. The thickness of a functional individual layer is preferably from 5 nm to 50 nm, particularly preferably from 8 nm to 25 nm. In this thickness range, advantageously high transmittance in the visible spectral range and particularly advantageous electrical conductivity are achieved.

The flat electrodes can in principle be formed by any electrically conductive layer that can be electrically contacted.

The functional element is preferably a multilayer film with two outer carrier films. In such a multilayer film, the flat electrodes and the active layer are arranged between the two carrier films. Here, “outer carrier film” means that the carrier films form the two surfaces of the multilayer film. The functional element can thus be provided as a laminated film that can be processed advantageously. The functional element is advantageously protected against damage, in particular, corrosion, by the carrier films. The multilayer film contains, in the order indicated, at least the first carrier film, the first flat electrode, the active layer, the second flat electrode, and the second carrier film.

Preferably, the first carrier film and/or the second carrier film contain(s) at least one polymer that does not fully melt in the autoclave process, preferably polyethylene terephthalate (PET). Particularly preferably, the first and the second carrier film are made of a PET film. This is particularly advantageous in terms of the stability of the multilayer film. The carrier films can, however, also contain, for example, ethylene vinyl acetate (EVA) and/or polyvinyl butyral (PVB), polypropylene, polycarbonate, polymethyl methacrylate, polyacrylate, polyvinyl chloride, polyacetate resin, casting resins, acrylates, fluorinated ethylene-propylenes, polyvinyl fluoride, and/or ethylene tetrafluoroethylene. The thickness of each carrier film is preferably from 0.1 mm to 1 mm, particularly preferably from 0.1 mm to 0.2 mm. The carrier films according to the invention are preferably transparent. The flat electrodes are preferably arranged on one surface of the carrier film, i.e., on exactly one of the two sides of the carrier film (i.e., on its front side or its back side). The carrier films are oriented in the layer stack of the multilayer film such that the flat electrodes are arranged adjacent the active layer.

In the context of the invention, the term “electrically adjustable optical properties” means those properties that are infinitely adjustable, but also those that can be switched between two or more discrete states.

In addition to the active layer and the flat electrodes, the functional element can, of course, have other layers known per se, for example, barrier layers, blocking layers, antireflection layers, protective layers, and/or smoothing layers.

Functional elements as multilayer films are commercially available. The functional element to be integrated is typically cut in the desired shape and size from a multilayer film of larger dimensions. This can be done mechanically, for example, with a knife. In an advantageous embodiment, the cutting is done using a laser. It has been demonstrated that, in this case, the side edge is more stable than with mechanical cutting. With mechanically cut side edges, there can be a risk that the material will pull back, which is visually conspicuous and adversely affects the aesthetics of the pane.

In an advantageous embodiment, the functional element has edge sealing. The edge sealing circumferentially covers the side edge of the functional element and prevents, in particular, the diffusion of chemical components of the thermoplastic intermediate layer, for example, plasticizers, into the active layer. At least along the lower edge of the functional element, which is visible in through-vision in windshields, and preferably, along all side edges, the edge sealing is formed by a transparent colorless adhesive or a transparent colorless adhesive tape. For example, acrylic or silicone-based adhesive tapes can be used as edge sealing. The transparent colorless edge sealing has the advantage that the edge of the functional element is not distractingly conspicuous in through-vision through the windshield. Preferably, such an edge sealing is also used with non-visible side edges, for example, in the case of roof panels or at the edge regions of the windshield that are concealed by masking print.

The functional element is integrated between the first pane and the second pane of the laminated pane via an intermediate layer. The intermediate layer preferably comprises a first thermoplastic laminating film, which bonds the functional element to the first pane, and a second thermoplastic laminating film, which bonds the functional element to the second pane. Typically, the intermediate layer is formed by at least the first and the second thermoplastic laminating film, which are arranged flat atop one another and are laminated to one another, with the functional element inserted between the two layers. The regions of the laminating films overlapping the functional element then form the regions that bond the functional element to the panes. In other regions of the pane where the thermoplastic laminating films make direct contact, they can fuse during lamination such that the two original layers are no longer discernible and, instead, there is a homogeneous intermediate layer.

A thermoplastic laminating film can, for example, be formed by a single thermoplastic film. A thermoplastic laminating film can also be formed from sections of different thermoplastic films whose side edges are adjacent. In addition to a first thermoplastic laminating film or a second thermoplastic laminating film, additional thermoplastic laminating films can also be present. These can, if need be, also be used for embedding additional films comprising functional layers, for example, infrared-reflecting layers or acoustically damping layers.

The thermoplastic laminating films can, as already discussed using the example of windshields and roof panels, also include tinted or colored regions. Such films can be obtained, for example, by coextrusion. Alternatively, an untinted film segment and a tinted or colored film segment can be combined to form a thermoplastic laminating film. The tinted or colored region can be homogeneously colored or tinted, in other words, can have location-independent transmittance. However, the tinting or coloring can also be inhomogeneous; in particular, a transmittance progression can be realized. In one embodiment of a windshield, the transmittance level in the tinted or colored region decreases at least in sections with increasing distance from the upper roof edge. Thus, sharp edges of the tinted or colored region can be avoided such that the transition from the sun visor to the transparent region of the windshield is gradual, which appears more attractive aesthetically.

In an advantageous embodiment, the region of the thermoplastic laminated pane oriented in the direction of a pane used as an outer pane of the vehicle, i.e., the region between the functional element and the outer pane, is tinted. This creates a particularly aesthetic impression of the vehicle observed from the outside. The region of the other thermoplastic laminated pane between the functional element and the inner pane can, optionally, be additionally colored or tinted.

In a preferred embodiment, the functional element, more precisely the side edges of the functional element, is circumferentially surrounded by a thermoplastic frame film. The frame film is implemented like a frame with a recess into which the functional element is inserted. The thermoplastic frame film can be formed by a thermoplastic film in which the recess had been cut out. Alternatively, the thermoplastic frame film can also be composed of a plurality of film sections around the functional element. Thus, the intermediate layer is formed, in a preferred embodiment, from a total of at least three thermoplastic laminating films arranged flat atop one another, wherein the frame film, as the middle layer, has a recess in which the functional element is arranged. During production, the thermoplastic frame film is arranged between the first and the second thermoplastic laminating film, with the side edges of all thermoplastic films preferably situated congruently. The thermoplastic frame film preferably has roughly the same thickness as the functional element. This compensates for the local difference in thickness of the windshield, which is introduced by the locally limited functional element, such that glass breakage during lamination can be avoided.

The side edges of the functional element visible in through-vision through the laminated pane are preferably arranged flush with the thermoplastic frame film such there is no gap between the side edge of the functional element and the associated side edge of the thermoplastic frame film. This is true in particular for the lower edge of a functional element as a sun visor of a windshield, in which this edge is typically visible. Thus, the boundary between the thermoplastic frame film and the functional element is visually less conspicuous.

Automobile glazings, in particular windshields, rear windows, and roof panels, usually have a surrounding peripheral masking print made of an opaque enamel, which serves in particular to protect the adhesive used for installation of the pane against UV radiation and to obscure it visually. This peripheral masking print is preferably also used to obscure the edges of the functional element that are situated in the edge region of the glazing. The bus bars and the required electrical connections are also installed in the region of the masking print. In this manner, the functional element is advantageously integrated into the appearance of the laminated pane. Preferably, at least the pane used as the outer pane has such a masking print; particularly preferably, both the first pane and the second pane (inner pane and outer pane) are printed such that through-vision is prevented from both sides.

The functional element can also have cutouts, for instance, in the region of so-called sensor windows or camera windows. These regions are provided to be equipped with sensors or cameras whose function would be impaired by a adjustable functional element in the beam path, for example, rain sensors.

The functional element is preferably arranged over the entire width of the laminated pane, minus an edge region on both sides with a width of, for example, 2 mm to 20 mm. The functional element preferably also has a distance from the upper edge of, for example, 2 mm to 20 mm. The functional element is thus encapsulated within the intermediate layer and is protected against contact with the surrounding atmosphere and against corrosion.

The first thermoplastic laminating film and the second thermoplastic laminating film and, optionally, the thermoplastic frame film as well, preferably contain at least polyvinyl butyral (PVB), ethylene vinyl acetate (EVA), and/or polyurethane (PU), particularly preferably PVB.

The thickness of each thermoplastic laminating film as well as the frame film is preferably from 0.2 mm to 2 mm, particularly preferably from 0.3 mm to 1 mm, in particular from 0.3 mm to 0.5 mm, for example, 0.38 mm.

The first pane and the second pane are preferably made of glass, particularly preferably of soda lime glass, as is customary for window panes. The panes can, however, also be made of other types of glass, for example, quartz glass, borosilicate glass, or aluminosilicate glass, or of rigid clear plastics, for example, polycarbonate or polymethyl methacrylate. The panes can be clear, or also tinted or colored. If the laminated pane is used as a windshield, it should have adequate light transmittance in the central field of vision, preferably at least 70% in the primary through-vision zone A per ECE-R43.

The outer pane, the inner pane, and/or the intermediate layer can have other suitable coatings that are known per se, for example, anti-reflecting coatings, non-stick coatings, anti-scratch coatings, photocatalytic coatings, or solar protection coatings or low-E coatings.

The thickness of the first pane and the second pane can vary widely and thus be adapted to the requirements in the individual case. The first pane and the second pane preferably have thicknesses of 0.5 mm to 5 mm, particularly preferably of 1 mm to 3 mm.

The invention also includes a method for producing a laminated pane according to the invention, wherein at least
a) a functional element is provided,
b) a group of first bus bars is attached on the first flat electrode and at least one second bus bar is attached on the second flat electrode,
c) at least one separating line, which divides the first flat electrode into at least two segments, is introduced into the first flat electrode of the functional element,
d) at least one recess is introduced in the first flat electrode in the region of at least one separating line,
e) at least one first thermoplastic laminating film is placed on a first pane, the functional element is placed on the first thermoplastic laminating film, at least one second thermoplastic laminating film and a second pane are arranged atop one another in this order on the functional element,
f) the first pane and the second pane are bonded by lamination, wherein an intermediate layer with an embedded functional element is formed from the first thermoplastic laminating film and the second thermoplastic laminating film.

Here, the at least one recess insulates the region of the first flat electrode positioned within the recess from the portion of the first flat electrode positioned outside the recess.

The functional element is preferably provided in the form of a multilayer film comprising, in this order, a first carrier film, an active layer, and a second carrier film, wherein the flat electrodes are attached on the surfaces of the carrier films facing the active layer. The advantage of a multilayer film with electrically switchable optical properties resides in simple production of the glazing. The actual functional element is advantageously protected against damage, in particular corrosion, by the carrier films and can be prepared before production of the glazing even in relatively large quantities, which can be desirable for economic and technical processing reasons. The multilayer film can, during production of the laminated pane, simply be inserted into the composite, which is then laminated using conventional methods.

The introduction of the at least one separating line in step c) is preferably done by a laser method. The separating lines are preferably generated by means of laser-induced degeneration within the flat electrodes. One such laser-induced degeneration is, for example, the removal of the flat electrode or a chemical change in the flat electrode. By means of the laser-induced degeneration, an interruption of the electrical conductivity of the layer is achieved.

The separating lines are preferably produced through the carrier film nearest the flat electrode to be processed. The laser is focused through this carrier film onto the flat electrode.

A pulsed solid-state laser is preferably used as the laser for producing the separating lines. It has proven advantageous to select the wavelength of the radiation of the laser for generating the separating lines in the range from 150 nm to 1200 nm, preferably in the range from 300 nm to 1200 nm. This range is particularly suitable when using conventional electrically conductive layers and conventional carrier films. The wavelength range of the laser is selected such that the separating lines are selectively introduced into the electrically conductive layer serving as a flat electrode.

Preferably used as the laser for producing the separating lines is a solid-state laser, particularly preferably an IR laser, for example, with a wavelength of 1030 nm. The laser is operated in pulsed mode. This is particularly advantageous in terms of high-power density and effective introduction of the electrically nonconductive separating line. The pulse energy is, for example, 10 μJ to 50 μJ.

The electrical contacting of the flat electrodes of the functional element is preferably done before introduction of the separating lines, but can optionally also take place thereafter.

The bus bars are preferably realized in the form of a printed and baked conductive structure. The printed bus bars contain at least one metal, preferably silver. Suitable silver printing pastes are available commercially and are known to the person skilled in the art.

For the selective contacting of a flat electrode with a bus bar, the flat electrode must first be exposed from the multilayer film. Here, in a first step, one carrier film of the multilayer film including the flat electrode situated on the carrier film is cut back. The active layer thus exposed is removed, for example, by mechanical abrasion using a solvent. After removal of the active layer, the adjacent flat electrode is revealed and can be electrically conductively contacted by printing the bus bar.

When multiple bus bars are arranged near one another, as, for example, in the case of a group of first bus bars along one edge, the stripping of the region to be contacted is usually done in one step for all bus bars adjacent one another. In order to design the production process as simple as possible, even the region of the multilayer film between adjacent first bus bars is stripped.

When the described contacting method is used, the contacting of the first and the second bus bar is done on the first or second flat electrode starting from different surfaces of the multilayer film. Thus, for the contacting of a first flat electrode on a first carrier film, the second carrier film is cut back, the active layer is removed, and the bus bars are attached from the side of the removed second carrier film. Analogously, for the contacting of the second flat electrode on the second carrier film, the first carrier film is cut back. Accordingly, the first bus bars and the second bus bars are not positioned congruently when this method is used.

The bus bars are provided, in a manner known to the person skilled in the art, with connection cables, for example, in the form of flat conductors that are routed out of the pane composite in order to be connected to an external power source.

Any prints present, for example, opaque masking prints and printed bus bars for the electrical contacting of the functional element are preferably applied by screen printing.

The recesses introduced in the first flat electrode in the region of the separating lines are preferably introduced by means of laser drilling at least in the first carrier film and the first flat electrode. Preferably used is a laser in the wavelength range 150 nm to 1200 nm, preferably in the range from 300 nm to 1200 nm. The laser beam is first directed onto the outer surface of the first carrier film facing the surroundings, and the laser beam is moved over the surface along a closed circumferential contour of the recess to be produced. The surface is removed in layers, creating the bore to be produced. The drilling continues until at least the first flat electrode is penetrated by the drilling along the contour of the recess within the full layer thickness of the flat electrode. Optionally, the bore can be implemented as a through-hole, wherein the bore penetrates all layers of the functional element. To create the recess, a solid-state laser is preferably used, particularly preferably an IR laser, for example, with a wavelength of 1030 nm. The laser is operated in pulsed mode with a pulse repetition rate of 10,000 to 400,000 Hz, for example, 25,000 Hz. The scanning speed is preferably selected between 0.01 m/s and 5 m/s. The pulse energy is preferably 10 μJ to 50 μJ per pulse. The pulse duration of the laser is preferably less than or equal to 20 ns, particularly preferably less than or equal to 10 ps, in particular less than or equal to 400 fs. If only one recess is desired in the first carrier film with the first flat electrode, 5 to 20 scanning operations are generally required to cut through these layers. The number of scanning operations increases accordingly if a through-opening is to be created.

For incorporating the functional element into a laminated pane, a layer stack of the individual components is first created. For this, a first pane and a second pane, which function as the inner pane and the outer pane of the laminated pane, are provided. These can be planar or curved, preferably congruently curved. At least one first thermoplastic laminating film is placed on a first pane. The functional element is placed on the first thermoplastic laminating film. Optionally, a thermoplastic frame film that surrounds the functional element like a passepartout can be added. Arranged on the functional element, atop one another in this order are at least one second thermoplastic laminating film and a second pane. Optionally, in addition to the thermoplastic laminating films mentioned, further thermoplastic laminating films and/or carrier films with functional layers can also be inserted into the composite.

The first pane and the second pane are bonded by lamination to form a laminated pane. The lamination is preferably done under the action of heat, vacuum, and/or pressure. It is possible to use lamination methods known per se, for example, autoclave methods, vacuum bag methods, vacuum ring methods, calender methods, vacuum laminators, or combinations thereof.

The features of the invention explained for the method apply analogously for the laminated pane according to the invention and vice versa.

The invention also includes the use of a laminated pane according to the invention as building glazing or vehicle glazing, preferably as vehicle glazing, in particular as a windshield or roof panel of a motor vehicle.

The invention is explained in detail with reference to drawings and exemplary embodiments. The drawings are schematic representations and are not to scale. The drawings in no way restrict the invention. They depict:

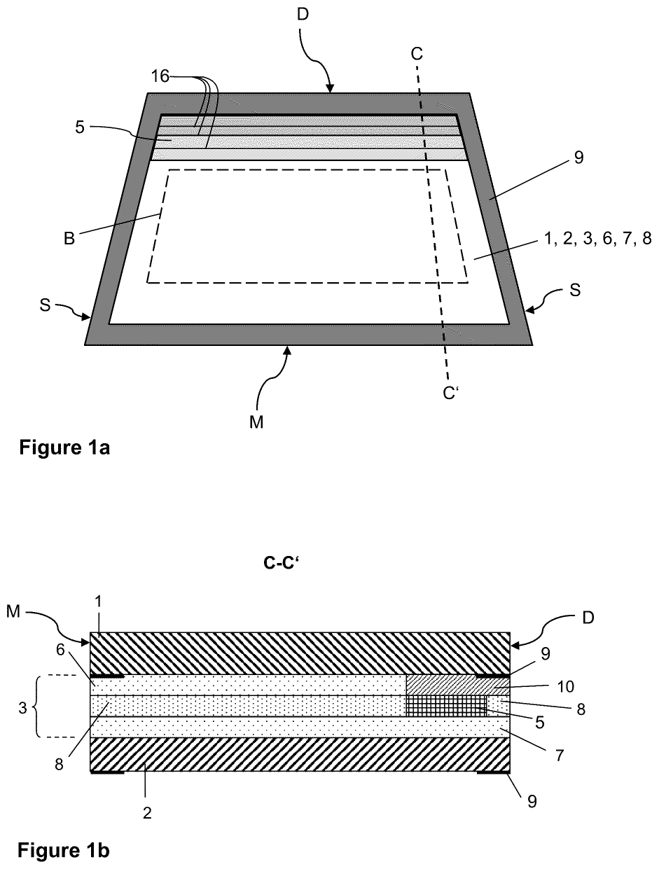

FIG. 1a a plan view of an embodiment of a laminated pane according to the invention as a windshield,

FIG. 1b a cross-section through the windshield according to the invention of FIG. 1a along the section line CC′,

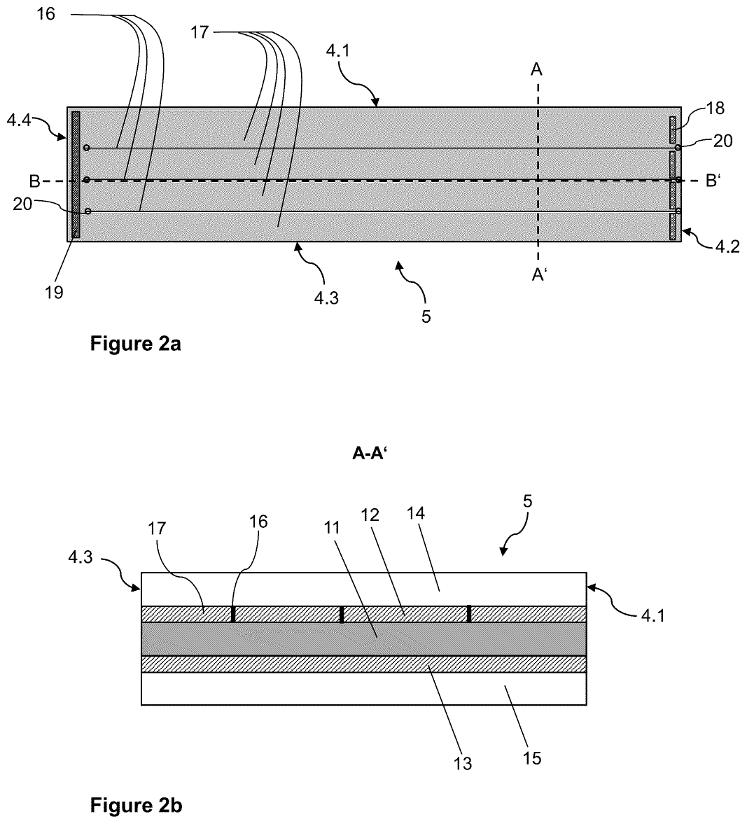

FIG. 2a the functional element 5 of the windshield of FIGS. 1a and 1b,

FIG. 2b a cross-section through the functional element 5 of FIG. 2a along the section line AA′,

FIG. 2c a cross-section through the functional element 5 of FIG. 2a along the section line BB′,

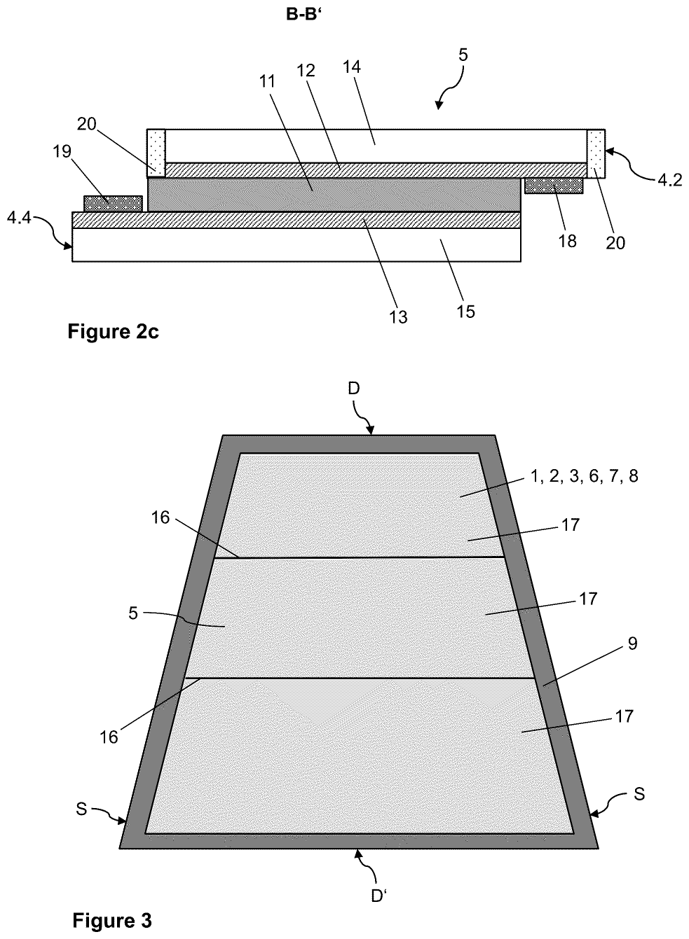

FIG. 3 a plan view of an embodiment of a laminated pane according to the invention as a roof panel,

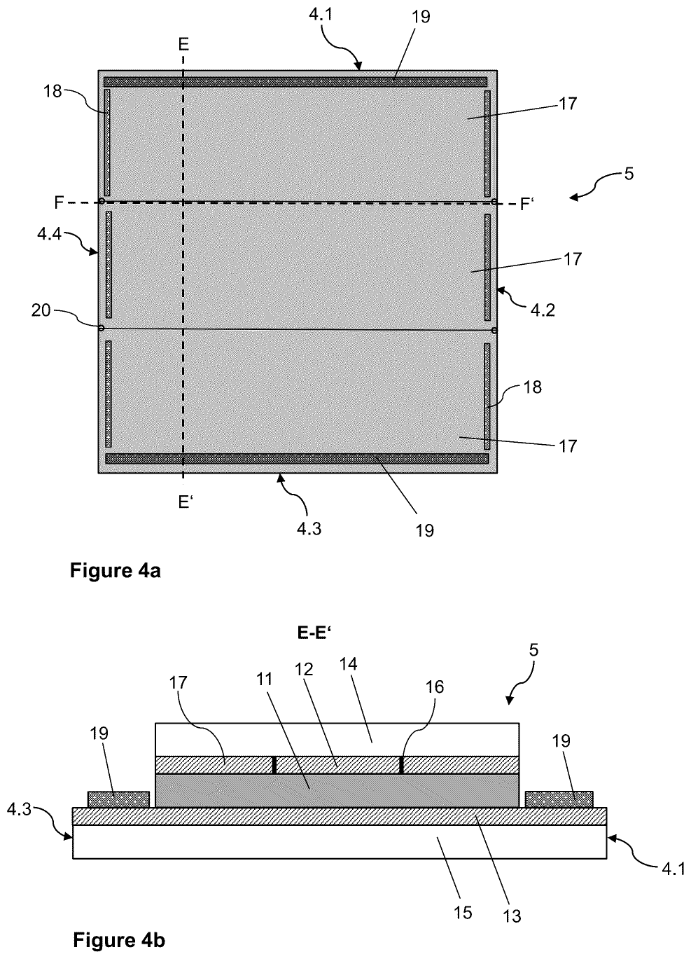

FIG. 4a the functional element 5 of the roof panel of FIG. 3,

FIG. 4b a cross-section through the functional element 5 of FIG. 4a along the section line EE′,

FIG. 4c a cross-section through the functional element 5 of FIG. 4a along the section line FF′,

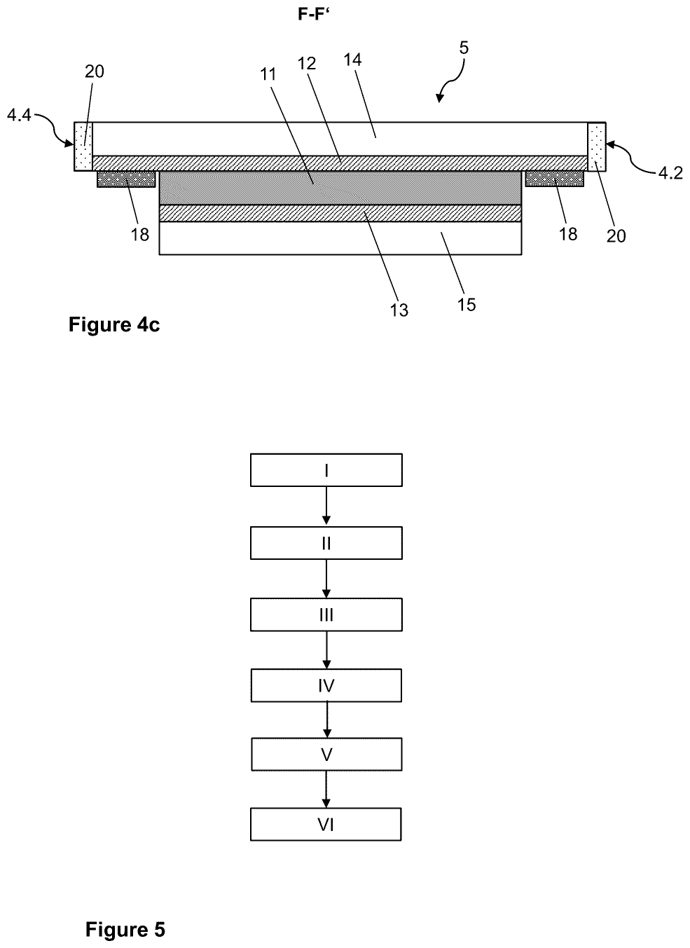

FIG. 5 an exemplary embodiment of the method according to the invention using a flowchart.

FIG. 1a depicts a plan view of a laminated pane according to the invention, which is implemented as a windshield of a motor vehicle. FIG. 1b depicts a cross-sectional view of the windshield of FIG. 1a along the section line CC′. The windshield comprises a first pane 1, serving as an outer pane, and a second pane 2, as an inner pane. The inner pane is the pane directed toward the vehicle's interior, whereas the outer pane points toward the vehicle's surroundings. The first pane 1 and the second pane 2 are joined to one other via an intermediate layer 3. The first pane 1 has a thickness of 2.1 mm and is made of a green-colored soda lime glass. The second pane 2 has a thickness of 1.6 mm and is made of a clear soda lime glass. The laminated pane as a windshield has a front roof edge D facing the roof in the installed position and an engine edge M facing the engine compartment in the installed position.

The windshield is equipped with a functional element 5 as an electrically adjustable sun visor that is installed in a region above the central field of vision B (as defined in ECE-R43). The sun visor is formed by a commercially available PDLC multilayer film as a functional element 5, which is integrated into the intermediate layer 3. The height of the sun visor is, for example, 21 cm. The intermediate layer 3 comprises a total of three thermoplastic laminating films 6, 7, 8, which are in each case implemented as a thermoplastic film with a thickness of 0.38 mm made of PVB. The first thermoplastic laminating film 6 is bonded to the first pane 1; the second thermoplastic laminating film 7, to the second pane 2. The thermoplastic frame film 8 positioned therebetween has a cutout, into which the cut-to-size PDLC multilayer film is inserted with an exact fit, in other words, flush on all sides. The third thermoplastic layer thus forms, so to speak, a sort of passepartout for the functional element 5, which is thus encapsulated all around in a thermoplastic material and is protected thereby. The first thermoplastic laminating film 6 optionally has a tinted region 10 that is arranged between the functional element 5 and the first pane 1. The light transmittance of the windshield is thus additionally reduced in the region of the sun visor and the milky appearance of the PDLC functional element 5 is mitigated in the diffusive state. The aesthetics of the windshield thus become significantly more attractive. In the case shown, the lower edges of the tinted region and of the PDLC functional element 5 are arranged flush. This is, however, not necessarily the case.

The laminated pane according to the invention has, in its embodiment as a windshield of FIG. 1a, a circumferential masking print 9, which conceals both the adhesive connection of the windshield to the vehicle body and the electrical contacting of the flat electrodes of the functional element 5. The circumferential peripheral masking print 9 is implemented by an opaque enamel on the interior-side surfaces (facing the interior of the vehicle in the installed position) of the first pane 1 and the second pane 2. The distance of the functional element 5 from the front roof edge D and the side edges of the windshield is less than the width of the masking print 9 such that the side edges 4.1, 4.2, 4.4 of the functional element 5—with the exception of the side edge 4.3 pointing toward the central field of vision B—are concealed by the masking print 9. The electrical connections and the recesses of the separating lines are also reasonably attached in the region of the masking print 9 and thus advantageously concealed.

In a particularly convenient embodiment, the functional element 5 is controlled by a capacitive switch area arranged in the region of the sun visor, wherein the driver specifies the degree of darkening by means of the location at which he touches the pane. Alternatively, the sun visor can even be controlled by contactless methods, for example, by gesture recognition, or as a function of the pupil or eyelid state detected by a camera and suitable evaluation electronics.

The side edges of the functional element 5 are provided circumferentially with an edge seal (not shown) that is formed by a transparent acrylic adhesive tape. This prevents diffusion into or out of the active layer 11. Since the edge seal is transparent, the lower side edge, which is not concealed by the masking print 9, is also not distractingly visible. The edge seal runs circumferentially around the side edges of the multilayer film and extends, starting from the side edges, a few millimeters over the surfaces of the carrier films 14, 15 facing away from the active layer 11. The edge seal 10 prevents, in particular, the diffusion of plasticizers and other adhesive components of the thermoplastic frame film 8 into the active layer 11, as a result of which the aging of the functional element 5 is reduced.

A so-called “high flow PVB”, which has stronger flow behavior compared to standard PVB films, can preferably be used for the thermoplastic laminating films 6, 7 and the thermoplastic frame film 8. The layers thus flow more strongly around the functional element 5, creating a more homogeneous visual impression, and the transition from the functional element 5 to the frame film 8 is less conspicuous. The “high flow PVB” can be used for all or for only one or more of the thermoplastic films 6, 7, 8 having direct contact with the functional element 5.

FIG. 2a depicts a plan view of the functional element 5 of the windshield of FIG. 1a before integration of the functional element 5 into the windshield, wherein the electrical contacting of the functional element 5 can also be seen. FIGS. 2b and 2c depict cross-sections through the functional element of FIG. 2a along the section lines AA′ and BB′, respectively. The adjustable functional element 5 is a multilayer film, consisting of an active layer 11 between two flat electrodes 12, 13 and two carrier films 14, 15. The active layer 11 contains a polymer matrix with liquid crystals dispersed therein, which align themselves as a function of the electrical voltage applied to the flat electrodes, by which means the optical properties can be adjusted. The carrier films 14, 15 are made of PET and have a thickness of, for example, 0.125 mm. The carrier films 14, 15 are provided with a coating of ITO facing the active layer 11 and having a thickness of approx. 100 nm, which forms the first flat electrode 12 and the second flat electrode 13. The flat electrodes 12, 13 can be connected to the onboard electrical system via bus bars 18, 19 and connection cables (not shown). The bus bars 18, 19 are formed by a silver-containing screen print. The first flat electrode 12 has three separating lines 16 with, in each case, a width of 100 μm, introduced by means of a laser process, and which divide the first flat electrode 12 into four segments 17. The separating lines 16 run within the first flat electrode 12 between the side edges 4.2 and 4.4. At the side edge 4.2 that is formed by the first carrier film 14 with the first flat electrode 12, the separating lines 16 run all the way to this side edge 4.2. At the opposite side edge 4.4, the separating lines 16 run at least up to the edge of the first flat electrode 12 nearest the side edge 4.4. In practice, the separating lines 16 are preferably introduced continuously between the opposite side edges 4.2, 4.2, with the separating lines 16 also running through the region of the second bus bar 19, in which the first carrier film 14 with the first flat electrode 12 is removed. This causes no impairment of the function of the second bus bar 19 or the second flat electrode 13, but is easier to implement from a process technology standpoint. The separating lines 16 are spaced approximately 5 cm apart or, in the case of the segments at the edge, approximately 5 cm from the nearest side edge 4.1, 4.3. The side edges 4.1, 4.2, 4.3, 4.4 add up to form the circumferential edge of the functional element. The separating lines 16 electrically isolate the segments 17 from one another. The number of segments 17 can be freely selected depending on the application or customer requirements. The first flat electrode 12 has in each case one first bus bar 18 per segment 17, i.e., a total of four first bus bars 18. In the installed position of the functional element 5, the side edge 4.2 of the functional element 5, which accommodates the first bus bars 18, is arranged at a side edge of the windshield (adjacent the A-pillars of the vehicle body). The second bus bar 19, which makes electrically conductive contact with the second flat electrode 13, is attached at the side edge 4.4, which is opposite the side edge 4.2. In the installed position, the side edge 4.4 is also arranged adjacent an A-pillar of the vehicle body. The separating lines 16 run between the side edges 4.2, 4.4 within the first flat electrode 12. At the side edge 4.2, which carries the first bus bars 18, the separating lines 16 run between adjacent first bus bars 18 through to the side edge 4.2. Directly at the side edge 4.2, recesses introduced in the form of laser bores are introduced overlapping with each of the separating lines 16. Also, in the vicinity of the second bus bar 19 at a distance of approx. 1 mm from the second bus bar 19 and offset relative thereto in the direction of the surface center of the functional element 5, a recess 20 is situated in the region of each separating line 16. FIG. 2c depicts a cross-section along the section line BB′, which depicts the contacting of the bus bars 18, 19 on the flat electrodes 12, 13. The second carrier film 15, the second flat electrode 13, and the active layer 11 are removed in the region of the functional element 5 that is intended for the first bus bars 18. The first bus bars 18 are printed by screen printing onto the first flat electrode 12 thus exposed. The first bus bars 18 occupy a maximum possible width corresponding to the distance between adjacent separating lines 16 or between the separating line 16 and the side edge 4.1 or 4.3. Care must be taken to be sure that the bus bar 18 is printed exclusively within the associated segment 17, in order to prevent a short-circuit between adjacent segments 17. The second bus bar 19 ensures the electrical contacting of the second flat electrode 13. In this region of the second bus bar 19, the first carrier film 14 is removed with the first flat electrode 12 and the active layer 11. The side edge of the first carrier film 14 is set back in comparison with the side edge 4.4 in the region of the second bus bar 19 in the direction of the surface center of the functional element 5. In particular, at this set-back side edge of the first carrier film 14, defects of the separating lines 16 introduced in the first flat electrode 12 occur. The recesses 20 that are introduced into this region of the separating lines 16, provide electrical isolation of the defects, as a result of which leakage currents between the segments are avoided. All recesses 20 have a diameter of approx. 2 mm and are introduced by means of laser drilling, with the recess 20 penetrating at least the first carrier film 14 and the first flat electrode 12 in a circular manner along the contour of the recess 20. The recesses 20 adjacent the second bus bar 19 can also project into the active layer 11 or be manufactured as through-openings.

FIG. 3 depicts a plan view of an embodiment of a laminated pane according to the invention as a roof panel. The roof panel comprises a first pane 1, which serves as the outer pane, and a second pane 2, as the inner pane. Here, the inner pane is the pane facing the vehicle's interior, whereas the outer pane points toward the vehicle's surroundings. The first pane 1 and the second pane 2 are joined to one another via an intermediate layer 3. The first pane 1 is made of clear soda lime glass with a thickness of 2.1 mm. The second pane 2 is made of soda lime glass with a thickness of 1.6 mm and is tinted gray. The tinted inner glass contributes to the attractive appearance of the pane, even for the vehicle occupant when looking through the roof panel. The laminated pane as a roof panel has a front roof edge D in the installed position of the windshield and a rear roof panel D′ facing the rear pane in the installed position.

The roof panel is equipped with a functional element 5 as large-area shading, wherein the functional element is formed by a commercially available PDLC multilayer film that is integrated into the intermediate layer 3. The structure of the intermediate layer 3 corresponds essentially to that described in FIGS. 1a and 1b, when, in contrast thereto, the functional element extending in the entire through-vision region of the glazing. In the embodiment as a roof panel as well, the intermediate layer 3 is formed by the three thermoplastic laminating films 6, 7, 8, as described in FIGS. 1a and 1b. These are implemented in each case by a thermoplastic film with a thickness of 0.38 mm made of PVB. The first thermoplastic laminating film 6 is bonded to the first pane 1; the second thermoplastic laminating film 7, to the second pane 2. The thermoplastic frame film 8 positioned therebetween has a cutout, into which the cut-to-size PDLC multilayer film is inserted with an exact fit, i.e., flush on all sides. Depending on the thickness of the multilayer film and a resultant difference in thickness relative to the region without the functional element 5, the frame film 8 can be dispensed with. This is also dependent on the complexity of the bending of the laminated pane. Generally speaking, in the case of small differences in thickness between areas with a functional element and areas without a functional element and in the case of low complexity of the bending, a frame film can be dispensed with.

The first thermoplastic laminating film 6 and the second thermoplastic laminating film 7 are tinted gray in order to make the appearance of the roof panel attractive.

Optionally, an additional thermoplastic laminating film (not shown) can be introduced adjacent the outer pane (first pane 1). Carrier films with functional layers, for example, a carrier film with an infrared reflecting coating, can be incorporated via the additional thermoplastic laminating film. The infrared reflecting coating is oriented in the direction of the first pane 1 (outer pane) and serves to reduce the heating of the passenger compartment by solar radiation.

The roof panel according to the invention likewise has the circumferential masking print 9 already described for a windshield according to the invention, which conceals both the adhesive bond of the windshield to the vehicle body and the electrical contacting of the flat electrodes of the functional element 5. The distance of the functional element 5 from the front roof edge D, from the rear roof edge D′, and from the side edges of the roof panel is less than the width of the masking print 9 such that the side edges 4.1, 4.2, 4.3, 4.4 of the functional element 5 are concealed by the masking print 9. The electrical connections are also reasonably attached in the region of the masking print 9 and thus advantageously concealed.

FIG. 4a depicts a plan view of the functional element 5 of the roof panel of FIG. 3 before integration of the functional element 5 into the laminated pane, wherein the electrical contacting of the functional element 5 can also be seen. FIG. 4b depicts a cross-section through the functional element of FIG. 4a along the section line EE′; FIG. 4c depicts a cross-section along the section line FF′. The adjustable functional element 5 is a multilayer film, which corresponds in its composition to that described in FIG. 2a. The first flat electrode 12 has two separating lines 16 with a width in each case, of 100 μm, introduced by means of a laser process, and which divide the first flat electrode 12 into three segments 17. The distance between the separating lines depends on the size of the roof panel, with the through-vision region of the pane divided by the separating line 16 into three subregions roughly equal in area. The separating lines 16 electrically isolate the segments 17 from one another. The number of segments 17 can be freely selected depending on the application or customer requirements. The contacting of the segments 17 essentially corresponds to that described in FIGS. 2a, 2b, and 2c. In contrast thereto, the first flat electrode 12 has, in each case, two first bus bars 18 per segment 17, i.e., a total of 6 first bus bars 18. The first bus bars 18 associated with a segment 17 are situated at opposite side edges 4.2, 4.4 of the functional element 5.

The side edges 4.2, 4.4 of the functional element 5, which accommodate the first bus bars 18, are arranged, in the installed position of the functional element 5, at the side edges of the roof panel (above the side doors of the vehicle). A cross-section through the functional element of FIG. 4a along the section line FF′ corresponds in its schematic structure to that depicted in FIG. 4c. The contacting of the flat electrodes 12, 13 is basically analogous to that described in FIG. 2a, 2b, 2c. In contrast thereto, the separating lines 16 run through, on both side edges 4.2, 4.4 opposite one another between adjacent bus bars 18, with the side edges 4.2, 4.4 formed in each case by the first carrier film 14. The second carrier film 15 is, in each case, set back in the direction of the surface center of the functional element 5 at the side edges 4.2, 4.4. In each case, immediately adjacent the side edges 4.2, 4.4 in the region of the separating lines 16, a recess 20 is introduced at each separating line 16, electrically isolating possible defects of the separating lines 16. The recesses are implemented analogously to those described in FIG. 2a-2c. In contrast to the functional element 5 as a sun visor described in FIG. 2a, the functional element 5 of FIG. 4a provided for full-surface shading of a roof panel has an additional second bus bar 19. Since all side edges 4.1, 4.2, 4.3, 4.4 of the functional element are positioned outside the through-vision region of the pane and are concealed by the peripheral masking print 9, all side edges are available for contacting the flat electrodes. A second bus bar 19 is arranged at the front roof edge D of the roof panel. Another second bus bar 19 is arranged along the rear roof edge D′ at the opposite side edge 4.3 of the functional element 5. A cross-section along the section line EE′ of the functional element of FIG. 4a is depicted in FIG. 4b. The structure is analogous to that described in FIG. 2b, wherein, in contrast thereto, along two opposite side edges 4.1, 4.3 of the functional element 5, the first carrier film 14, the first flat electrode 12, and the active layer 11 are removed in one area in each case and one second bus bar 19 is printed in each case. The use of two second bus bars 19 and two first bus bars 18 in each case per segment 17 is advantageous in order to achieve uniform voltage distribution, even in the case of large dimensions of the functional element 5.

The distribution of a second bus bar and the group of first bus bars along the side edges 4.1, 4.2, 4.3, 4.4 can, in principle, be selected regardless of whether the functional element is a sun visor of a windshield or a large-area functional element of a roof panel and is described here only by way of example. However, in the case of a functional element as a sun visor, it should be noted that the side edge of the functional element pointing in the direction of the surface center of the windshield is located in the visible area of the pane and, for aesthetic reasons, should bear no bus bar. Regardless of this possible distribution of the bus bars along the pane edges, the recesses of the separating lines according to the invention are helpful in avoiding leakage currents between adjacent segments.

FIG. 5 depicts, using a flowchart, an exemplary embodiment of the production method according to the invention comprising the steps:
I Providing a functional element 5,
II Attaching a group of first bus bars 18 on the first flat electrode 12 and attaching at least one second bus bar 19 on the second flat electrode 13,
III Introducing at least one separating line 16 into the first flat electrode 12 of the functional element 5 by means of a laser process, wherein the at least one separating line 16 divides the first flat electrode 12 into at least two segments 17,
IV Introducing, in each case, at least two recesses 20 in the region of each of the separating lines 16 in the first flat electrode 12 by means of laser drilling, with the recesses 20 located in each case in the vicinity of an edge of the first flat electrode 12, at which bus bars 18, 19 are arranged,
V Placing at least one first thermoplastic laminating film 6 on a first pane 1, placing the functional element 5 on the first thermoplastic laminating film 6, placing at least one second thermoplastic laminating film 7 on the functional element 5, and completing the layer stack with a second pane 2,
VI Laminating the first pane 1 and the second pane 2 to form a laminated pane, wherein an intermediate layer 3 with an embedded functional element 5 is formed from the first thermoplastic laminating film 6 and the second thermoplastic laminating film 7.

The recesses 20 isolate the region of the first flat electrode 12 that is located within the recesses 20 from the region of the first flat electrode 12 that is located outside the recesses 20. Thus, the defect-prone regions of the separating lines 16 are electrically isolated and leakage currents between adjacent segments are avoided.

### LIST OF REFERENCE CHARACTERS

1 first pane
2 second pane
3 intermediate layer
4.1, 4.2, 4.3, 4.4 side edges
5 functional element with electrically adjustable optical properties
6 first thermoplastic laminating film
7 second thermoplastic laminating film
8 thermoplastic frame film
9 masking print
10 tinted region of the first thermoplastic laminating film
11 active layer of the functional element 5
12 first flat electrode of the functional element 5
13 second flat electrode of the functional element 5
14 first carrier film
15 second carrier film
16 separating lines
17 segments
18 first bus bar
19 second bus bar
20 recess
D front roof edge
D′ rear roof edge
M engine edge
S side edges
A-N, C-C′, E-E′, F-F′ section lines

1. A laminated pane with an electrically controllable functional element which is switchable in segments, at least comprising a first pane, a second pane, which are joined to one another via an intermediate layer, and a functional element that is embedded in the intermediate layer,
wherein
the functional element comprises, flat atop one another in this order, at least a first carrier film, a first flat electrode, an active layer, a second flat electrode, and a second carrier film,
the first flat electrode is divided into a plurality of segments by at least one separating line,
a group of first bus bars electrically conductively contacts the first flat electrode,
at least one second bus bar electrically conductively contacts the second flat electrode, and
wherein in a region of the at least one separating line at least one recess is introduced in the first flat electrode, which at least one recess surrounds a portion of the first flat electrode and electrically insulates the portion of the first flat electrode situated within the at least one recess from a surface region of the first flat electrode situated outside the at least one recess.

2. The laminated pane according to claim 1, wherein the at least one recess is configured in the form of a through-hole or as a partial recess.

3. The laminated pane according to claim 1, wherein a distance between the at least one recess and the second bus bar is 0.2 mm to 20.0 mm.

4. The laminated pane according to claim 1, wherein the at least one recess is introduced in the region of the at least one separating line, which lies between two adjacent bus bars of the group of the first bus bars.

5. The laminated pane according to claim 1, wherein a diameter of the at least one recess is 0.5 mm to 5.0 mm.

6. The laminated pane according to claim 1, wherein the recesses are introduced by means of laser drilling at least into the first carrier film and the first flat electrode.

7. The laminated pane according to claim 1, wherein the functional element is a PDLC functional element.

8. The laminated pane according to claim 1, wherein the first bus bars and the second bus bars comprise an electrically conductive structure and have a thickness of 5 μm to 40 μm.

9. The laminated pane according to claim 1, wherein the first flat electrode and the second flat electrode contain at least a metal, a metal alloy, or a transparent conductive oxide, and have a thickness of 10 nm to 2 μm.

10. The laminated pane according to claim 1, wherein the intermediate layer has a first thermoplastic laminating film, which is arranged between the functional element and the first pane, and has a second thermoplastic laminating film, which is arranged between the functional element and the second pane.

11. The laminated pane according to claim 10, wherein the functional element is circumferentially surrounded by a thermoplastic frame film, which is arranged between the first thermoplastic laminating film and the second thermoplastic laminating film.

12. A method for producing a laminated pane according to claim 1, comprising:
a) providing a functional element,
b) attaching a group of first bus bars on the first flat electrode and attaching at least one second bus bar on the second flat electrode,
c) introducing at least one separating line, which divides the first flat electrode into at least two segments, in the first flat electrode of the functional element,
d) introducing at least one recess in the first flat electrode in the region of at least one separating line,
e) placing at least one first thermoplastic laminating film on a first pane, the functional element is placed on the first thermoplastic laminating film, at least one second thermoplastic laminating film and a second pane are arranged atop one another in this order on the functional element, and
f) joining the first pane and the second pane by lamination, wherein an intermediate layer with an embedded functional element is formed from the first thermoplastic laminating film and the second thermoplastic laminating film,
wherein the at least one recess electrically insulates the region of the first flat electrode within the recess from the region of the first flat electrode outside the recess.

13. The method according to claim 12, wherein the recesses are introduced by laser drilling at least into the first carrier film and the first flat electrode.

14. The method according to claim 12 or 13, wherein the separating lines in the first flat electrode are produced by laser-induced degeneration, by focusing a laser beam through the first carrier film onto the first flat electrode.

15. A method comprising providing a laminated pane according to claim 1 as building glazing or vehicle glazing.

16. The laminated pane according to claim 3, wherein the distance between the at least one recess and the second bus bar is 0.2 mm to 10.0 mm.

17. The laminated pane according to claim 5, wherein the diameter of the at least one recess is 0.8 mm to 3.0 mm.

18. The laminated pane according to claim 8, wherein the electrically conductive structure contains silver.

19. The laminated pane according to claim 9, wherein the first flat electrode and the second flat electrode contain a transparent conductive oxide.

20. The method according to claim 15, wherein the vehicle glazing is a windshield or a roof panel of a motor vehicle.
